(19) United States
(12) Patent Application Publication
(10) Pub. No.: US 2017/0280686 A1
(43) Pub. Date: Oct. 5, 2017

(54) Looping Leash and Collar

(71) Applicant: Jason R. Cory, Tulsa, OK (US)

(72) Inventor: Jason R. Cory, Tulsa, OK (US)

(21) Appl. No.: 15/480,194

(22) Filed: Apr. 5, 2017

Related U.S. Application Data
(60) Provisional application No. 62/318,595, filed on Apr. 5, 2016.

(51) Int. Cl. A01K 27/00; A44B 11/00

(52) U.S. Cl. CPC A01K 27/003; A44B 11/00; A01K 27/001; A01K 27/005

(57) ABSTRACT

A looping leash and collar is an apparatus that includes a handle strap, a collar strap, a leash strap, a first eyelet, a second eyelet, a first fastener, and a second fastener. The handle strap allows a user to grasp the apparatus. The collar strap attaches onto a pet.

The leash strap connects the handle strap to the collar strap. The first eyelet is terminally fixed to the handle strap, and the second eyelet is terminally fixed to the collar strap. The first eyelet and the second eyelet are tethered to each other by the leash strap, thereby allowing the handle strap and the collar strap to move independently of one another while restraining a pet. The first fastener allows the handle strap to loop into a noose configuration about the first eyelet. The second fastener allows the collar strap to loop into a noose configuration about the second eyelet.

The current application claims a priority to the U.S. Provisional Patent application Ser. No. 62/318,595 filed on Apr. 5, 2016.

### FIELD OF THE INVENTION

The present invention relates generally to leashes for pets. More specifically, the present invention is a looping leash and collar that provides a single continuous strap which can be configured to have two opposing terminal loops.

### BACKGROUND OF THE INVENTION

Pet care requires time, dedication, and consistency. One of the most common and demanding tasks of pet care is walking a pet, whether it is for exercise or for stimulating a pet to urinate or make a bowel movement. Although walking a pet may be fun, there is a lot of items that must be used while walking a pet. Typically, a leash and a handle is attached to a collar. However, pets do not like being restrained which results in a difficult and time consuming process of attaching the leash and handle to the collar. In addition to a leash-handle and a collar, an owner might have to bring along a bag and water while he or she is walking the pet.

The present invention serves to simplify this process as the present invention is a single continuous strap. The present invention loops about itself such that the attachment of the present invention onto a user and a pet is easier and faster. The present invention combines the function of a leash-handle and a collar into a single item so that the user does not need to concern himself or herself with multiple items in order to walk a pet.

### BRIEF DESCRIPTION OF THE DRAWINGS

FIG. 1 is a front perspective view of the present invention.

FIG. 2 is a rear perspective view of the present invention.

FIG. 3 is a front perspective view of the present invention, wherein the handle strap and the collar strap are in a noose configuration.

FIG. 4 is a top side view of the present invention.

FIG. 5 is a schematic view of the pressure-sensitive release latch of the present invention, wherein the pressure-sensitive release latch is engaged.

FIG. 6 is a schematic view of the pressure-sensitive release latch of the present invention, wherein the pressure-sensitive release latch is disengaged.

FIG. 7 is a schematic view of the free loop of the present invention, wherein the handle strap and the leash strap are in an annular configuration.

### DETAILED DESCRIPTION OF THE INVENTION

All illustrations of the drawings are for the purpose of describing selected versions of the present invention and are not intended to limit the scope of the present invention.

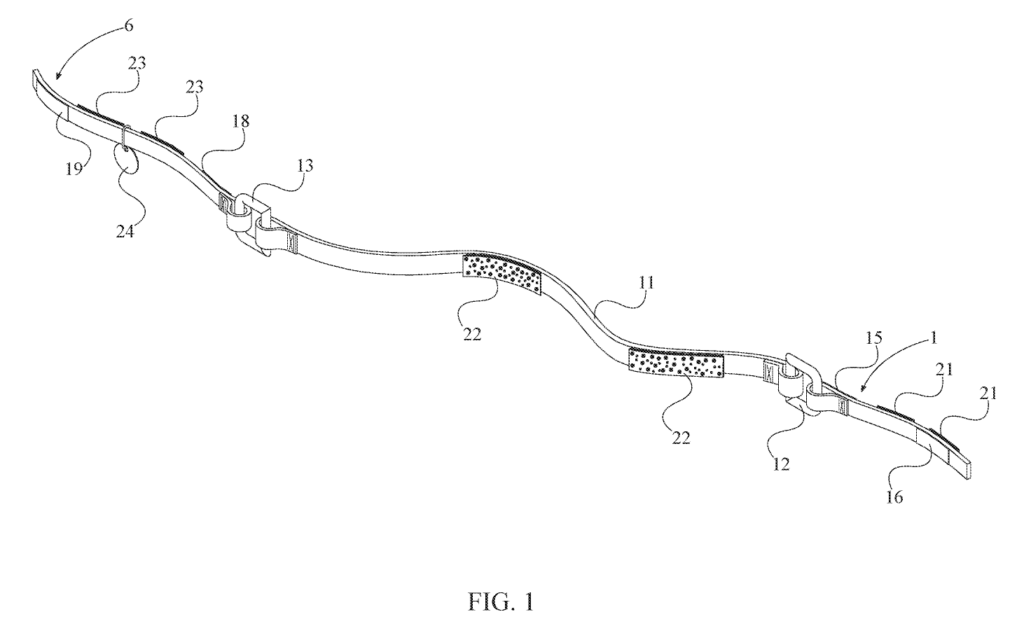

The present invention is a looping leash and collar that allows a user to restrain a pet while providing enough freedom for the pet to move around the user. The present invention provides a continuous strap that tethers the user to the pet without limited the movement of the pet or hurting the pet in any way. As shown in FIG. 1, the present invention comprises a handle strap 1, a collar strap 6, a leash strap 11, a first eyelet 12, a second eyelet 13, a first fastener 14, and a second fastener 17. The handle strap 1 allows a user to grip onto the present invention. The handle strap 1 may also mount the present invention onto an object or item so that the pet is confined within a given area while being able to freely move within the given area. The handle strap 1 is used to form a handle with an adjustable circumference that is able to better conform to the user's grip. The collar strap 6 is used to form a collar with an adjustable circumference that is able to comfortably restrain the user's pet. The circumference of the collar formed by the collar strap 6 can be adjusted so that the present invention may accommodate a variety of pets and comfortably surround the neck of the pet. The leash strap 11 tethers the collar strap 6 to the handle strap 1 and consequently allows the user to connect to the pet. The leash strap 11 allows a pet to freely move within a perimeter around the user, which is defined by the length of the leash strap 11. The first eyelet 12 and the second eyelet 13 connects the handle strap 1 to the least strap and the leash strap 11 to the collar strap 6, respectively. The first eyelet 12 allows the leash strap 11 to move freely about the handle strap 1, without the handle strap 1 applying any pressure onto the user's grip as a result of the position of the leash strap 11 about the handle strap 1. Similarly, the second eyelet 13 allows the collar strap 6 to move freely about the leash strap 11, without the leash strap 11 getting tangled or without the leash strap 11 applying any pressure to the handle strap 1. The first fastener 14 and the second fastener 17 allows the handle strap 1 and the collar strap 6 to be adjustable in length according to the width of the user's grip and the pet's neck, respectively.

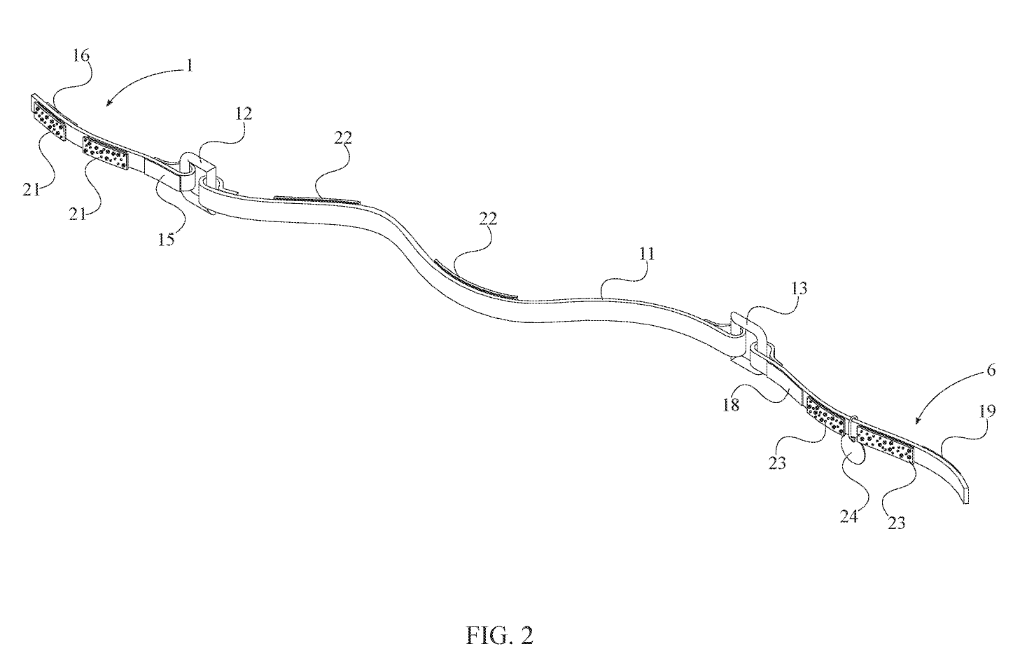

In order to accommodate a variety of users and pets, the first fastener 14 comprises a first proximal piece 15 and a first distal piece 16, as shown in FIG. 1 and FIG. 2. The engagement of the first proximal piece 15 and the first distal piece 16 secures the length of the circumference of the handle strap 1 about the user's grip. Similarly, the second fastener 17 comprises a second proximal piece 18 and a second distal piece 19, also shown in FIG. 1 and FIG. 2. The engagement of the second proximal piece 18 and the second distal piece 19 secures the length of the collar strap 6 about the pet's neck. In the preferred embodiment of the present invention, the first proximal piece 15, the first distal piece 16, the second proximal piece 18, and the second distal piece 19 are either the hooks portion of a hook-an-loop fastener or the loops portion of the hook-and-loop fastener that are able to attach to one another.

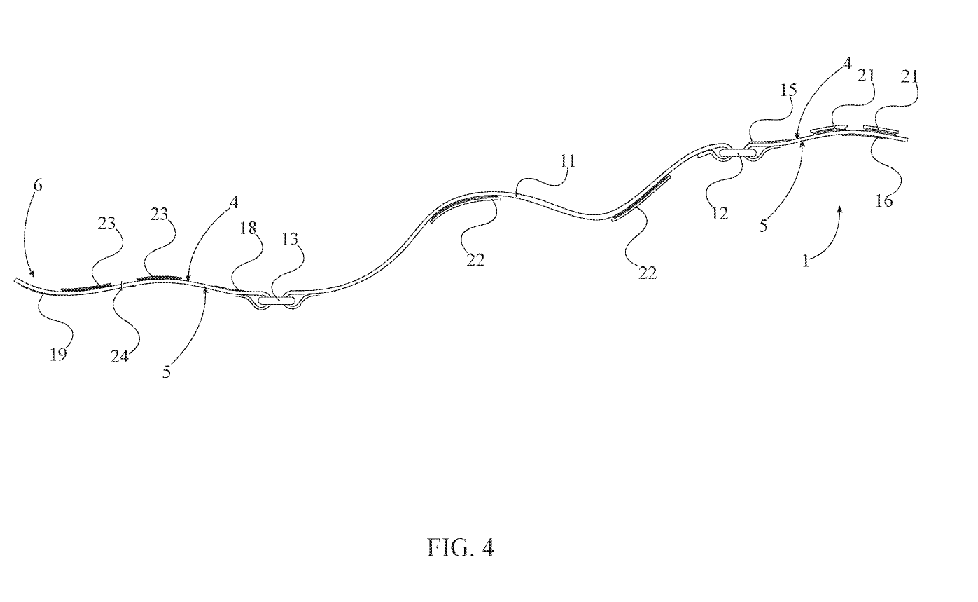

The overall configuration of the aforementioned components allows a user to restrain a pet with a single continuous strap. In order for the handle strap 1 to move independently of the leash strap 11, the first eyelet 12 is terminally fixed to the handle strap 1, as illustrated in the top view of FIG. 4. The handle strap 1 is securable onto itself as the first distal piece 16 is terminally fixed to the handle strap 1, opposite to the first eyelet 12, and as the first proximal piece 15 is laterally connected to the handle strap 1 in between the first distal piece 16 and the first eyelet 12. In order for the leash strap 11 to move independently of the collar strap 6, the second eyelet 13 is terminally fixed to the collar strap 6, as illustrated in FIG. 4. The collar strap 6 is securable onto itself as the second distal piece 19 is terminally fixed to the collar strap 6, opposite to the second eyelet 13, and as the second proximal piece 18 is laterally connected to the collar strap 6 in between the second distal piece 19 and the second eyelet 13. More specifically, the first eyelet 12 and the second eyelet 13 are tethered to each other by the leash strap 11, thereby allowing the pet to move freely about the user. In an alternate embodiment of the present invention, the second eyelet 13 may be fixed to the leash strap 11 and detachably attached to the collar strap 6 so that the leash strap 11 and the handle strap 1 may be readily attached to an existing collar of a pet.

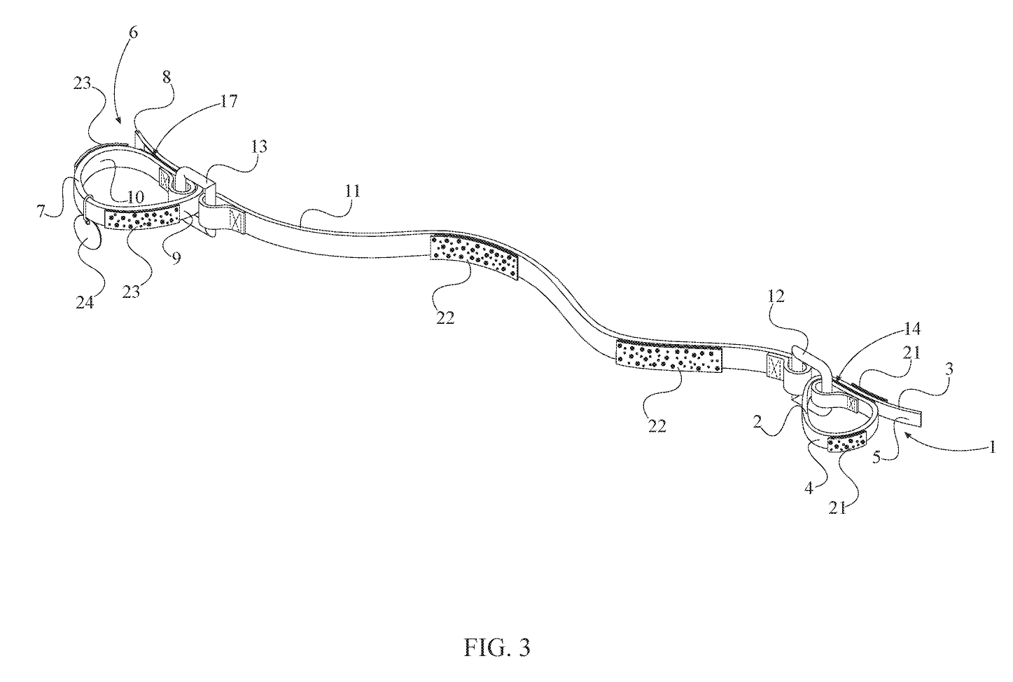

The handle strap 1 is fastened about the user's grip so that the user may maneuver the present invention. The handle strap 1 is secured about the user's grip once the handle strap 1 is in a noose configuration. When the handle strap 1 is in a noose configuration, the handle strap 1 comprises a looping portion 2 and an overlapping portion 3, as shown in FIG. 3. The first proximal piece 15 is fixed onto the looping portion 2, and the first distal piece 16 is fixed onto the overlapping portion 3. The overlapping portion 3 traverses through the first eyelet 12, and the first proximal piece 15 is engaged by the first distal piece 16. Thus, the noose configuration for the handle strap 1 forms a handle that can be grasped by the user. Similarly, in order to fasten the collar strap 6 about the pet's neck, the collar strap 6 is in a noose configuration as well. The collar strap 6 comprises a looping portion 7 and an overlapping portion 8, which are shown in FIG. 3. The second proximal piece 18 is fixed onto the looping portion 7, and the first distal piece 16 is fixed onto the overlapping portion 8. The overlapping portion 8 traverses through the second eyelet 13, and the second proximal piece 18 is engaged by the second distal piece 19. Thus, the noose configuration for the collar strap 6 forms a collar that can be used to restrain the pet's neck.

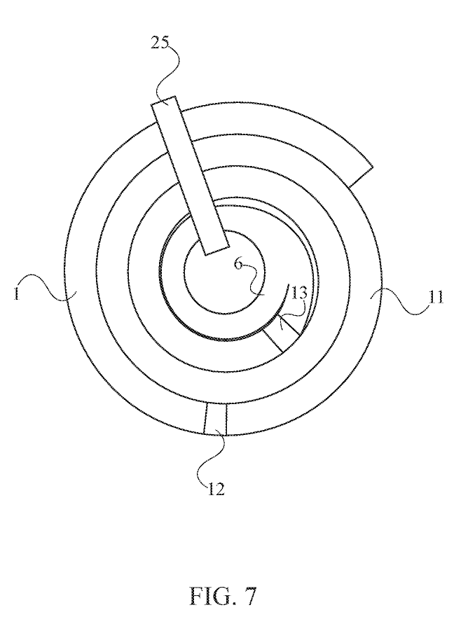

In order to retract the present invention, the preferred embodiment of the present invention further comprises a free loop 25. When the handle strap 1 and the leash strap 11 are in an annular configuration, the handle strap 1 and the leash strap 11 are wound about the collar strap 6 so that each do not get tangled with one another. The annular configuration allows the present invention to be worn by a pet while the handle strap 1 is not being held by the user or attached to an object. The free loop 25 is looped around the handle strap 1, the leash strap 11, and the collar strap 6, as shown in FIG. 7, so that the present invention may be worn by a pet without the handle strap 1 and the leash strap 11 dragging behind the pet and possibly getting tangled with or hooked by a nearby object.

In order for the length of the circumference of the handle strap to be adjustable, the handle strap 1 further comprises a first lateral face 4 and a second lateral face 10. The first lateral face 4 is exposed to the surrounding environment, and the second lateral face 5 presses against the user's hand. The first proximal piece 15 is mounted onto the first lateral face 4, and the first distal piece 16 is mounted onto the second lateral face 5 so that the handle strap 1 is securable onto itself. In one embodiment of the present invention, the first proximal piece 15 is discretely distributed with the first lateral face 4 so that the first lateral face 4 is partially exposed. In another embodiment of the present invention, the first proximal piece 15 is continuously distributed with the first lateral face 4 so that the first distal piece 16 may attach at any point along the first lateral face 4 and the adjustable length of the circumference of the handle strap 1 is not limited.

Similarly, the collar strap 6 further comprises a first lateral face 9 and a second lateral face 10. The first lateral face 9 is exposed to the surrounding environment, and the second lateral face 10 presses against the pet's neck. The second proximal piece 18 is mounted onto the first lateral face 9, and the second distal piece 19 is mounted onto the second lateral face 10 so that the collar strap 6 is securable onto itself. In one embodiment of the present invention, the second proximal piece 18 is discretely distributed with the first lateral face 9 so that the first lateral face 9 is partially exposed. In another embodiment of the present invention, the second proximal piece 18 is continuously distributed with the first lateral face 9 so that the second distal piece 19 may attach at any point along the first lateral face 9 and the adjustable length of the circumference of the collar strap 6 is not limited.

In the preferred embodiment of the present invention, the present invention comprises a first set of interchangeable patches 21, a second set of interchangeable patches 22, and a third set of interchangeable patches 23. Each set of interchangeable patches is shown in FIG. 1, FIG. 2, FIG. 3, and FIG. 4. The first set of interchangeable patches 21, the second set of interchangeable patches 22, and the third set of interchangeable patches 23 allows a user to visually distinguish a looping leash and collar from a set of looping leashes and collars. More specifically, the first set of interchangeable patches 21 allows a user to visually distinguish the handle strap 1 from the leash strap 11 and the collar strap 6 as the first set of interchangeable patches 21 is mounted along the handle strap 1. The second set interchangeable patches 22 allows a user to visually distinguish the leash strap 11 from the handle strap 1 and the collar strap 6 as the second set of interchangeable patches 22 is mounted long the leash strap 11. The third set of interchangeable patches 23 allows a user to visually distinguish the collar strap 6 from the handle strap 1 and the leash strap 11 as the third set of interchangeable patches 23 is mounted along the collar strap 6. In the preferred embodiment of the present invention the first set of interchangeable patches 21 and the third set of interchangeable patches 23 attaches onto the first lateral face 4 of the handle strap 1 and the first lateral face 4 of the collar strap 6, respectively.

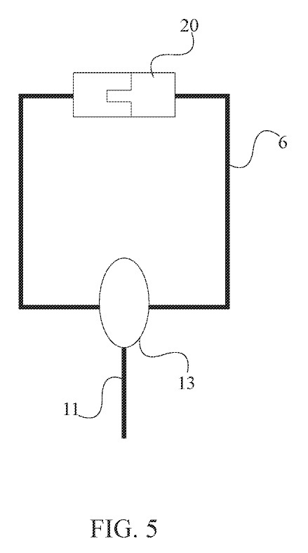

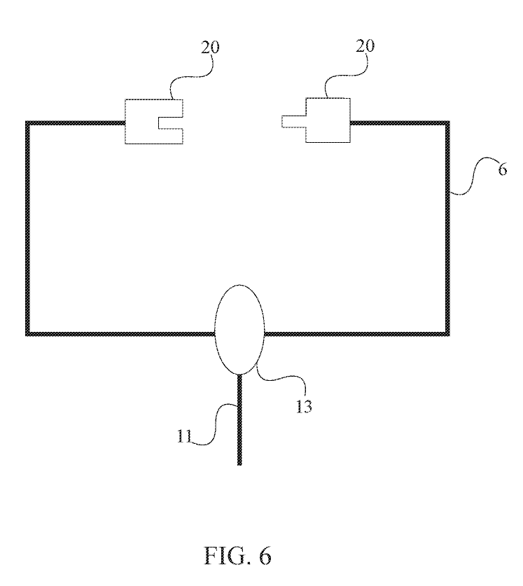

In an alternate embodiment of the present invention, the present invention further comprises a pressure-sensitive release latch 20. The pressure-sensitive release latch 20 breaks the loop, as defined by the noose configuration of the collar strap 6, if the loop applies too much pressure on the pet's neck. The pressure-sensitive release latch 20 is integrated into the collar strap 6 in order to release any hurtful or fatal pressure applied by the collar strap 6 against a pet's neck, as shown in the schematic view of FIG. 5. More specifically, the pressure-sensitive release latch 20 is positioned along the collar strap 6 in between the second proximal piece 18 and the second distal piece 19. This configuration preserves the length adjustability of the collar strap 6 while breaking the loop of the collar strap 6 in the event the collar strap 6 is too tight around the pet's neck. The pressure-sensitive release latch 20 is shown disengaged as a result of too much pressure being applied to the pet's neck in FIG. 6.

In another embodiment of the present invention, the present invention comprises an identification tag 24. The identification tag 24 identifies the corresponding pet to the collar strap 6. The identification tag 24 is detachably attached to the collar strap 6 as the collar strap 6 surrounds the neck of the pet so that the owner or any other person can easily identify the pet.

Although the invention has been explained in relation to its preferred embodiment, it is to be understood that many other possible modifications and variations can be made without departing from the spirit and scope of the invention as hereinafter claimed.

What is claimed is:

1. A looping leash and collar comprises:
a handle strap;
a collar strap;
a leash strap;
a first eyelet;
a second eyelet;
a first fastener;
a second fastener;
the first fastener comprises a first proximal piece and a first distal piece;
the second fastener comprises a second proximal piece and a second distal piece;
the first eyelet being terminally fixed to the handle strap;
the first distal piece being terminally fixed to the handle strap, opposite to the first eyelet;
the first proximal piece being laterally connected to handle strap in between the first distal piece and the first eyelet;
the second eyelet being terminally fixed to the collar strap;
the second distal piece being terminally fixed to the collar strap, opposite to the second eyelet;
the second proximal piece being laterally connected to collar strap in between the second distal piece and the second eyelet; and
the first eyelet and the second eyelet being tethered to each other by the leash strap.

2. The looping leash and collar as claimed in claim 1 comprises:
wherein the handle strap is in a noose configuration;
the handle strap comprises a looping portion and an overlapping portion;
the first proximal piece being fixed onto the looping portion;
the first distal piece being fixed onto the overlapping portion;
the overlapping portion traversing through the first eyelet; and
the first proximal piece being engaged by the first distal piece.

3. The looping leash and collar as claimed in claim 1 comprises:
wherein the collar strap is in a noose configuration;
the collar strap comprises a looping portion and an overlapping portion;
the second proximal piece being fixed onto the looping portion;
the second distal piece being fixed onto the overlapping portion;
the overlapping portion traversing through the second eyelet; and
the second proximal piece being engaged by the second distal piece.

4. The looping leash and collar as claimed in claim 3 comprises:
wherein the handle strap and the leash strap are in an annular configuration;
a free loop;
the handle strap and the leash strap being wound about the collar strap; and
the free loop being looped around the handle strap, the leash strap, and the collar strap.

5. The looping leash and collar as claimed in claim 1 comprises:
the handle strap comprises a first lateral face and a second lateral face;
the first proximal piece being mounted onto the first lateral face; and
the first distal piece being mounted onto the second lateral face.

6. The looping leash and collar as claimed in claim 1 comprises:
the collar strap comprises a first lateral face and a second lateral face;
the second proximal piece being mounted onto the first lateral face; and
the second distal piece being mounted onto the second lateral face.

7. The looping leash and collar as claimed in claim 1 comprises:
a pressure-sensitive release latch;
the pressure-sensitive release latch being integrated into the collar strap; and
the pressure-sensitive release latch being positioned along the collar strap in between the second proximal piece and the second distal piece.

8. The looping leash and collar as claimed in claim 1 comprises:
a first set of interchangeable patches; and
the first set of interchangeable patches being mounted along the handle strap.

9. The looping leash and collar as claimed in claim 1 comprises:
a second set of interchangeable patches; and
the second set of interchangeable patches being mounted along the leash strap.

10. The looping leash and collar as claimed in claim 1 comprises:
a third set of interchangeable patches; and
the third set of interchangeable patches being mounted along the collar strap.

11. The looping leash and collar as claimed in claim 1 comprises:
an identification tag; and
the identification tag being detachably attached to the collars strap.

12. A looping leash and collar comprises:
a handle strap;
a collar strap;
a leash strap;
a first eyelet;
a second eyelet;
a first fastener;
a second fastener;
a pressure-sensitive release latch;
a first set of interchangeable patches; and
a second set of interchangeable patches; and
a third set of interchangeable patches; and
the first fastener comprises a first proximal piece and a first distal piece;
the second fastener comprises a second proximal piece and a second distal piece;
the first eyelet being terminally fixed to the handle strap;
the first distal piece being terminally fixed to the handle strap, opposite to the first eyelet;
the first proximal piece being laterally connected to handle strap in between the first distal piece and the first eyelet;
the second eyelet being terminally fixed to the collar strap;
the second distal piece being terminally fixed to the collar strap, opposite to the second eyelet;
the second proximal piece being laterally connected to collar strap in between the second distal piece and the second eyelet; and
the first eyelet and the second eyelet being tethered to each other by the leash strap.
the pressure-sensitive release latch being integrated into the collar strap;
the pressure-sensitive release latch being positioned along the collar strap in between the second proximal piece and the second distal piece;
the first set of interchangeable patches being mounted along the handle strap;
the second set of interchangeable patches being mounted along the leash strap; and
the third set of interchangeable patches being mounted along the collar strap.

13. The looping leash and collar as claimed in claim 12 comprises:
wherein the handle strap is in a noose configuration;
the handle strap comprises a looping portion and an overlapping portion;
the first proximal piece being fixed onto the looping portion;
the first distal piece being fixed onto the overlapping portion;
the overlapping portion traversing through the first eyelet; and
the first proximal piece being engaged by the first distal piece.

14. The looping leash and collar as claimed in claim 12 comprises:
wherein the collar strap is in a noose configuration;
the collar strap comprises a looping portion and an overlapping portion;
the second proximal piece being fixed onto the looping portion;
the second distal piece being fixed onto the overlapping portion;
the overlapping portion traversing through the second eyelet; and
the second proximal piece being engaged by the second distal piece.

15. The looping leash and collar as claimed in claim 14 comprises:
wherein the handle strap and the leash strap are in an annular configuration;
a free loop;
the handle strap and the leash strap being wound about the collar strap; and
the free loop being looped around the handle strap, the leash strap, and the collar strap.

16. The looping leash and collar as claimed in claim 12 comprises:
the handle strap comprises a first lateral face and a second lateral face;
the first proximal piece being mounted onto the first lateral face; and
the first distal piece being mounted onto the second lateral face.

17. The looping leash and collar as claimed in claim 12 comprises:
the collar strap comprises a first lateral face and a second lateral face;
the second proximal piece being mounted onto the first lateral face; and
the second distal piece being mounted onto the second lateral face.

18. The looping leash and collar as claimed in claim 12 comprises:
an identification tag; and
the identification tag being detachably attached to the collars strap.
